(19) United States
(12) Patent Application Publication
(10) Pub. No.: US 2026/0166572 A1
(43) Pub. Date: Jun. 18, 2026

(54) WOBBLE PLATE FOR SPRAYER CLEANING SYSTEMS

(71) Applicant: Techtronic Cordless GP, Anderson, SC (US)

(72) Inventors: Brian George, Spartanburg, SC (US); Justin Mast, Ware Shoals, SC (US); John Earl, Townville, SC (US)

(21) Appl. No.: 19/408,049

(22) Filed: Dec. 3, 2025

Related U.S. Application Data
(60) Provisional application No. 63/733,729, filed on Dec. 13, 2024.

(51) Int. Cl. B05B 3/00; B08B 3/02

(52) U.S. Cl. CPC B05B 3/008; B08B 3/026; B08B 2203/0223; B08B 2203/027; B08B 2203/0294

(57) ABSTRACT

A pump assembly for a sprayer washer is provided. The pump assembly includes a plurality of pistons extending between a first end and a second end and a wobble plate for driving the plurality of pistons. The wobble plate includes a first plate, a second plate pivotably coupled to the first plate, and at least one biasing member disposed between the first plate and the second plate. The biasing member is configured to bias the first plate and the second plate between a first tilt angle and a second tilt angle based on a pressure exerted on the wobble plate.

### CROSS-REFERENCE TO RELATED APPLICATIONS

This application claims priority to U.S. Provisional Patent Application No. 63/733,729, filed Dec. 13, 2024, the entire contents of which are incorporated herein by reference.

### FIELD

The present disclosure relates generally to a wobble plate for sprayer cleaning systems.

### BACKGROUND

Sprayer cleaning systems, such as pressure washers, power washers, high pressure sprayers, etc., are typically used for providing a continuous flow of pressurized fluid to a surface or object in order to remove dust, dirt, and debris therefrom. High pressure cleaning systems typically include a compressor for pressurizing the fluid, a pump, and a sprayer (e.g., a sprayer wand or sprayer gun). High pressure cleaning systems may be used for cleaning various objects or surfaces, such as sidewalks, driveways, homes, decks, automotive equipment, aerospace equipment, or other generally hard objects and surfaces.

### BRIEF DESCRIPTION

Aspects and advantages of the present disclosure will be set forth in part in the following description, or may be obvious from the description, or may be learned through practice of the technology.

In current sprayer cleaning systems, a nozzle may be integrated with or removably coupled to a fluid outlet of the sprayer. However, a flow rate of the fluid may be impacted by the nozzle type, such as a size or shape of the nozzle. Accordingly, improved pump systems for a sprayer cleaning systems are desired in the art. In particular, a pump system that addresses variations in fluid flow rate would be advantageous.

In accordance with one embodiment, a pump assembly for a sprayer washer is provided. The pump assembly includes a plurality of pistons extending between a first end and a second end and a wobble plate for driving the plurality of pistons. The wobble plate includes a first plate, a second plate pivotably coupled to the first plate, and at least one biasing member disposed between the first plate and the second plate. The biasing member is configured to bias the first plate and the second plate between a first tilt angle and a second tilt angle based on a pressure exerted on the wobble plate.

In accordance with another embodiment, a sprayer washer is provided. The sprayer washer includes a sprayer including a housing defining a fluid inlet and a fluid outlet, at least one nozzle removably coupled to the fluid inlet, and a pump assembly disposed within the housing of the sprayer in fluid communication with the fluid inlet and the fluid outlet. The at least one nozzle defines an orifice in fluid communication with the fluid outlet. The pump assembly includes a plurality of pistons and a wobble plate for driving the plurality of pistons. The wobble plate includes a first plate, a second plate pivotably coupled to the first plate, and at least one biasing member disposed between the first plate and the second plate. The wobble plate is configured to bias the first plate and the second plate between a first tilt angle and a second tilt angle based on a pressure exerted on the wobble plate.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1A is a perspective, exploded view of a high-pressure cleaning system in accordance with embodiments of the present disclosure;

FIG. 1B is a perspective view of a nozzle of the sprayer high-pressure cleaning system of FIG. 1A in accordance with embodiments of the present disclosure;

FIG. 1C is a perspective view of a nozzle of the sprayer high-pressure cleaning system of FIG. 1A in accordance with embodiments of the present disclosure;

FIG. 2 is a cross-sectional view of a sprayer of the sprayer cleaning system of FIG. 1A in accordance with embodiments of the present disclosure;

FIG. 3A is a detailed view of a pump assembly of the sprayer cleaning system of FIG. 1A in accordance with embodiments of the present disclosure;

FIG. 3B is a cross-sectional view of the pump assembly of FIG. 3A in accordance with embodiments of the present disclosure;

FIG. 4A is a side perspective view of a wobble plate of the pump assembly of FIG. 3A in accordance with embodiments of the present disclosure;

FIG. 4B is a top perspective view of the wobble plate of the pump assembly of FIG. 3A in accordance with embodiments of the present disclosure;

FIG. 4C is a bottom perspective view of the wobble plate of the pump assembly of FIG. 3A in accordance with embodiments of the present disclosure;

FIG. 5A is a cross-sectional view of the wobble plate of FIGS. 4A-4C at a first tilt angle in accordance with embodiments of the present disclosure;

FIG. 5B is a cross-sectional view of the wobble plate of FIGS. 4A-4C at a second tilt angle in accordance with embodiments of the present disclosure; and

FIG. 6 is a method for controlling a flow rate of the high-pressure cleaning system of FIG. 1A in accordance with embodiments of the present disclosure.

FIG. 7 is a graphical representation of flow rate relative to head pressure in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” “in contact with”, and the like refer to both direct coupling, fixing, attaching, or contacting, as well as indirect coupling, fixing, attaching, or contacting through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, sprayer cleaning systems typically include a compressor for pressurizing the fluid, a pump, and a sprayer. A pressure and a flow rate of the fluid flowing from a nozzle of the sprayer may be impacted by a type of the nozzle. For example, the pressure and flow rate may be reduced for nozzles having a larger orifice compared to nozzles having a smaller orifice. Accordingly, the present disclosure provides a pump system including a wobble plate for sprayer cleaning systems that provides an improved flow rate regardless of nozzle type for improved, efficient cleaning.

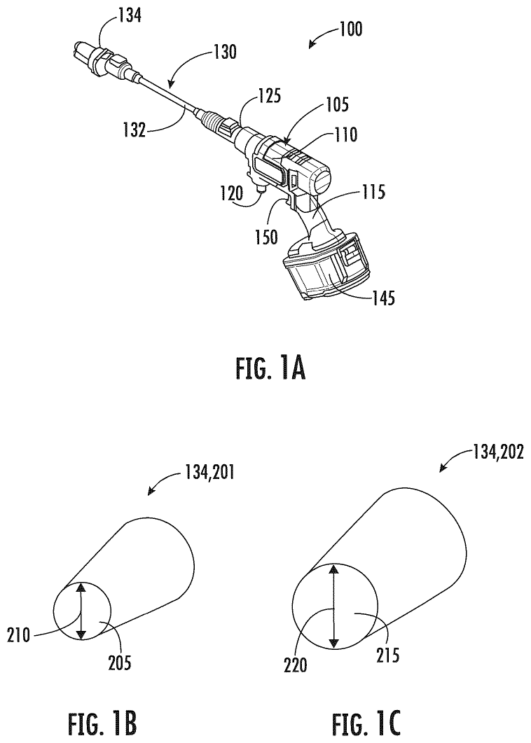

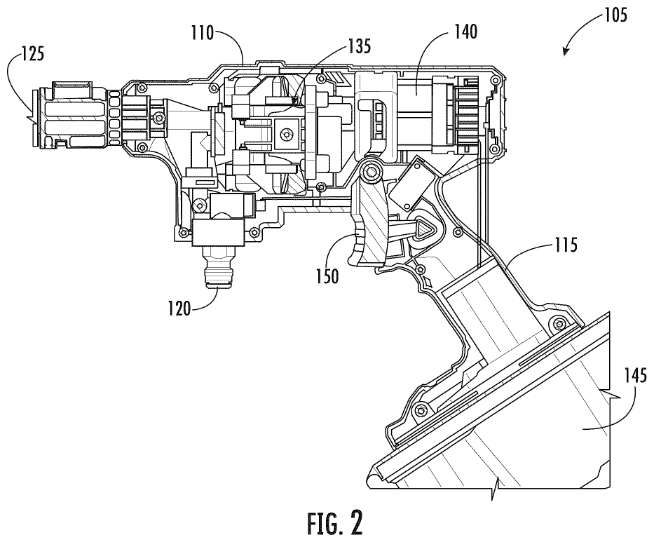

Referring now to the drawings, FIG. 1A illustrates a perspective, exploded view of a sprayer cleaning system 100, such as a high pressure washer or other high-pressure sprayer, in accordance with embodiments of the present disclosure. FIGS. 1B-1C illustrates a perspective view of a nozzle of the sprayer cleaning system 100 of FIG. 1A in accordance with embodiments of the present disclosure. FIG. 2 illustrates a cross-sectional view of a sprayer 105 of the sprayer cleaning system 100 of FIG. 1A in accordance with embodiments of the present disclosure.

With reference to FIG. 1A, the sprayer 105 includes a housing 110 and a handle 115 extending from an end of the housing 110. The sprayer 105 includes a fluid inlet 120 for receiving a fluid, such as water or other fluid, from an external fluid source. The sprayer 105 also includes a fluid outlet 125. Accordingly, the fluid may flow into the sprayer 105 at the fluid inlet 120 and out of the sprayer 105 through the fluid outlet 125. Moreover, a nozzle attachment 130 may be removably coupled to the fluid outlet 125 of the sprayer 105. As shown in FIG. 1A, the nozzle attachment 130 may include a wand 132 and a nozzle 134 removable coupled to the wand 132. One or both of the wand 132 and the nozzle 134 may be interchangeable. However, it should be understood that the nozzle attachment 130 may include any type of nozzle for directing the fluid from the sprayer 105 to a desired surface. In other example embodiments, the wand 132 may be omitted such that the nozzle 134 may be removably coupled to the fluid outlet 125 of the sprayer 105. In still other example embodiments, the nozzle attachment 130, including one or both of the wand 132 and the nozzle 134, may be integral with the fluid outlet 125 of the sprayer 105.

As mentioned above, the nozzle 134 may be interchangeable with a plurality of nozzles. For example, with reference to FIGS. 1B-1C, the nozzle 134 may include a first nozzle 201 and a second nozzle 202. The first nozzle 201 may define a first orifice 205 having a first diameter 210 and the second nozzle 202 may define a second orifice 215 having a second diameter 220 As shown in FIGS. 1B-1C, the second diameter 220 of the second orifice 215 may be greater than the first diameter 210 of the first orifice 205

As shown in FIG. 2, the sprayer 105 includes a pump assembly 135 and a motive device, such as an electric motor 140. The electric motor 140 is configured to drive the pump assembly 135. For example, the electric motor 140 may be mechanically coupled to the pump assembly 135 via a rotatable shaft (not shown). Additionally, the electric motor 140 may be powered by a power source 145. The power source 145 may be removably coupled to the sprayer 105 and may include one or more rechargeable batteries. In other example embodiments, the sprayer 105 may include a corded electric power source and/or a gas power source.

Still referring to FIG. 2, the sprayer 105 includes an actuator 150. The actuator 150 is disposed adjacent the handle 115. When depressed, the actuator 150 may engage the electric motor 140 to activate the pump assembly 135.

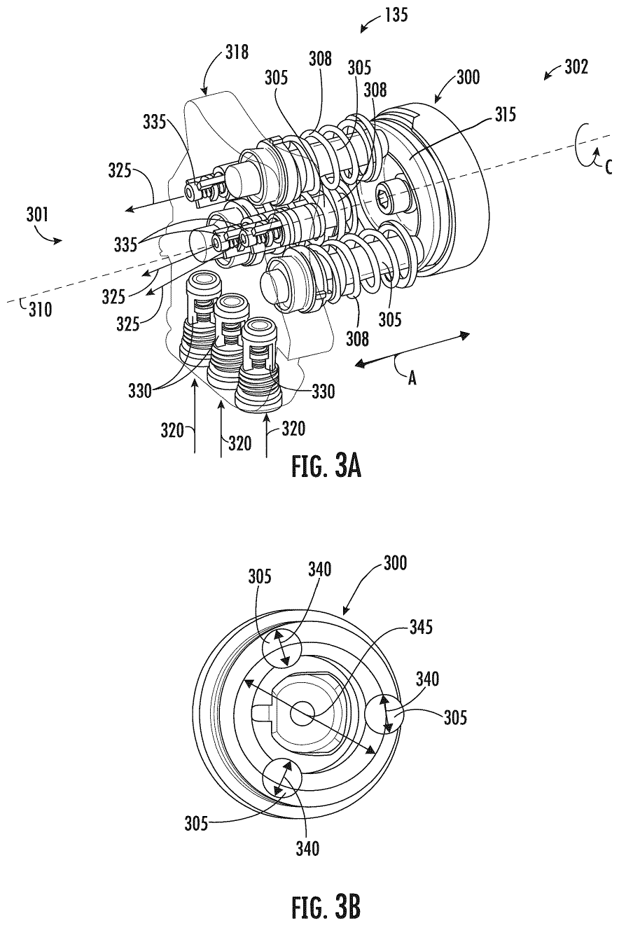

FIG. 3A illustrates a detailed view of the pump assembly 135 of the sprayer 105 of the sprayer cleaning system 100 of FIG. 1A in accordance with embodiments of the present disclosure. FIG. 3B illustrates a cross-sectional view of the pump assembly 135 of FIG. 3A in accordance with embodiments of the present disclosure. It should be understood that the pump assembly 135 may be used with any pressurized sprayer tool, including the sprayer 105 shown in FIG. 1A.

In at least one example embodiment, the pump assembly 135 includes a wobble plate 300 and a plurality of pistons 305 extending between a first end 301 and a second end 302. As shown in FIG. 3A, the second end 302 of each of the plurality of pistons 305 is configured to contact the wobble plate 300. The plurality of pistons 305 are disposed about a central axis 310 extending through the pump assembly 135. In at least one example embodiment, as shown in FIG. 3B, the plurality of pistons 305 are equally spaced about the central axis 310. In other example embodiments, the plurality of pistons 305 may be unequally spaced, radially, circumferentially, or both.

With reference to FIG. 3B, each of the plurality of pistons 305 define a piston diameter 340. The piston diameter 340 is defined by a straight line extending through a cross-section of each of the plurality of pistons 305. In at least one example embodiments, the piston diameter 340 is greater than or equal to about 5 millimeters and less than or equal to about 15 millimeters. For example, the piston diameter 340 may be about 10 millimeters. Moreover, the plurality of pistons 305 may define a piston pitch diameter 345 relative to the wobble plate 300. The piston pitch diameter 345 is defined by a straight line extending through a center of a circle extending through the center of each of the plurality of pistons 305. In at least one example embodiment, the piston pitch diameter 345 is greater than or equal to about 30 millimeters and less than or equal to about 45 millimeters. For example, the piston pitch diameter 345 may be about 38 millimeters.

Referring again to FIG. 3A, a piston biasing member 308 is coupled to each of the plurality of pistons 305. As shown in FIG. 3, the piston biasing member 308 may include a spring. The piston biasing member 308 is configured to bias each of the plurality of pistons 305 to maintain contact with the wobble plate 300.

The wobble plate 300 is configured to rotate in a circumferential direction C about the central axis 310 and drive the plurality of pistons 305 such that each of the plurality of pistons 305 is reciprocated in an axial direction A along the central axis 310. For example, the wobble plate 300 may be mechanically coupled to the electric motor 140 via a shaft (not shown) for driving rotation of the wobble plate 300. Additionally, as shown in FIG. 3A, the wobble plate 300 may include a thrust bearing 315 for contacting the second end 302 of the plurality of pistons 305.

Moreover, the pump assembly 135 defines at least one fluid chamber 318. The at least one fluid chamber 318 defines a plurality of fluid inlets, indicated by arrows 320, a plurality of fluid outlets, indicated by arrows 325. The plurality of fluid inlets 320 may be in fluid communication with the fluid inlet 120 of the sprayer 105 and the plurality of fluid outlets 325 may be in fluid communication with the fluid outlet 125 of the sprayer 105. The pump assembly 135 may also include a plurality of inlet valves 330 disposed in fluid communication with the plurality of fluid inlets 320 and a plurality of outlet valves 335 disposed in fluid communication with the plurality of fluid outlets 325. The plurality of fluid inlet valves 330 and the plurality of fluid outlet valves 335 may include check valves or any other one-way valve.

As shown in FIG. 3A, the pump assembly 135 may include three of the plurality of fluid inlets 320, three of the plurality of inlet valves 330, three of the plurality of fluid outlets 325, and three of the plurality of outlet valves 335. Accordingly, each of the plurality fluid inlets 320, the plurality of inlet valves 330, the plurality of fluid outlets 325, the plurality of outlet valves 335 may define a fluid passageway. Each fluid passageway may be fluidly isolated in some example embodiments. For example, the at least one fluid chamber 318 may define three chambers for each fluid passageway. Additionally, it should be understood that the pump assembly 135 may include any number of the plurality fluid inlets 320, the plurality of inlet valves 330, the plurality of fluid outlets 325, the plurality of outlet valves 335, such as one or more of each of the plurality fluid inlets 320, the plurality of inlet valves 330, the plurality of fluid outlets 325, and the plurality of outlet valves 335.

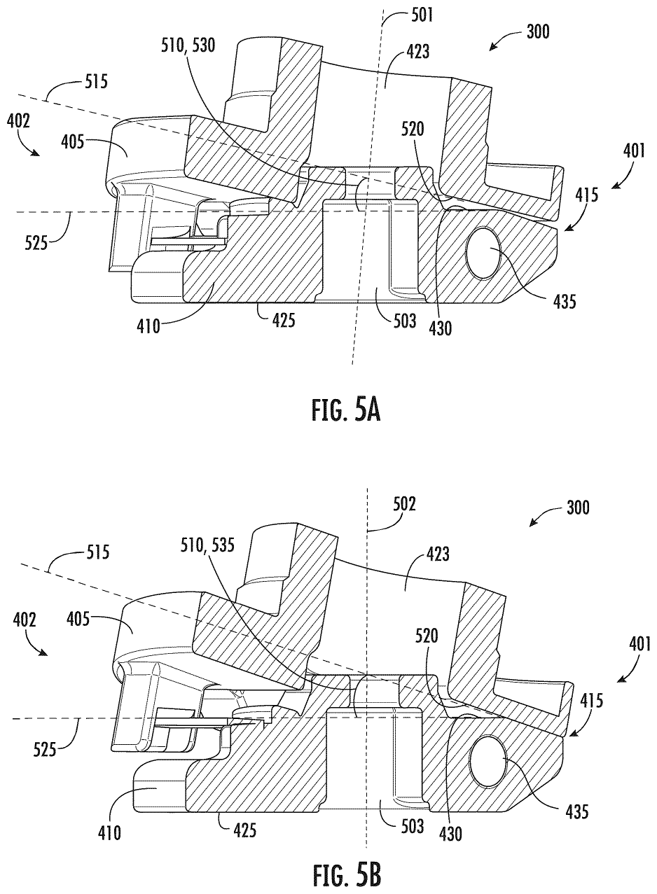

The wobble plate 300 is angled relative to an axis extending perpendicular to the central axis 310, as will be discussed in greater detail below with respect to FIGS. 5A-5B. As the wobble plate 300 rotates, the plurality of pistons 305 are reciprocated in a sequential manner. The plurality of pistons 305 may be at least partially disposed within the at least one fluid chamber 318. Accordingly, each of the plurality of pistons 305 draws fluid into the at least one fluid chamber 318 from the plurality of fluid inlets 320 and pushes the fluid, under pressure, from the at least one fluid chamber 318 to the plurality of fluid outlets 325 and out of the sprayer 105 through the fluid outlet 125. The plurality of inlet valves 330 allows the fluid to flow to the at least one fluid chamber 318 from the plurality of fluid inlets 320 as each of the plurality of pistons 305 move away from the at least one fluid chamber 318, and the plurality of outlet valves 335 allows the fluid to flow from the at least one fluid chamber 318 to the plurality of fluid outlets 325 as each of the plurality of pistons 305 move towards and/or into the at least one fluid chamber 318.

In at least one example embodiment, the plurality of pistons 305 may include three of the plurality of pistons 305, as shown in FIG. 3A. In such embodiment, the at least one fluid chamber 318 may define a number of fluid chambers equal to the number of the plurality of pistons 305. For example, the at least one fluid chamber 318 may define three fluid chambers, as mentioned above. However, it should be understood that the pump assembly 135 may include any number of the plurality of pistons 305 and any number of fluid chambers of the at least one fluid chamber 318.

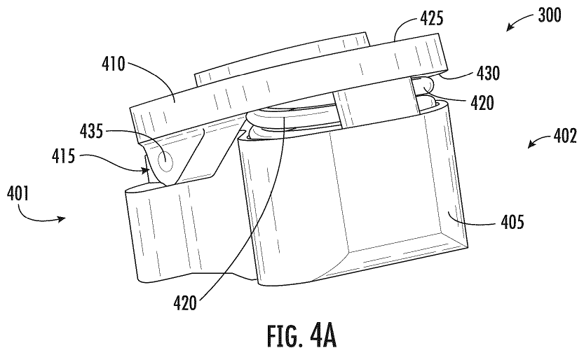

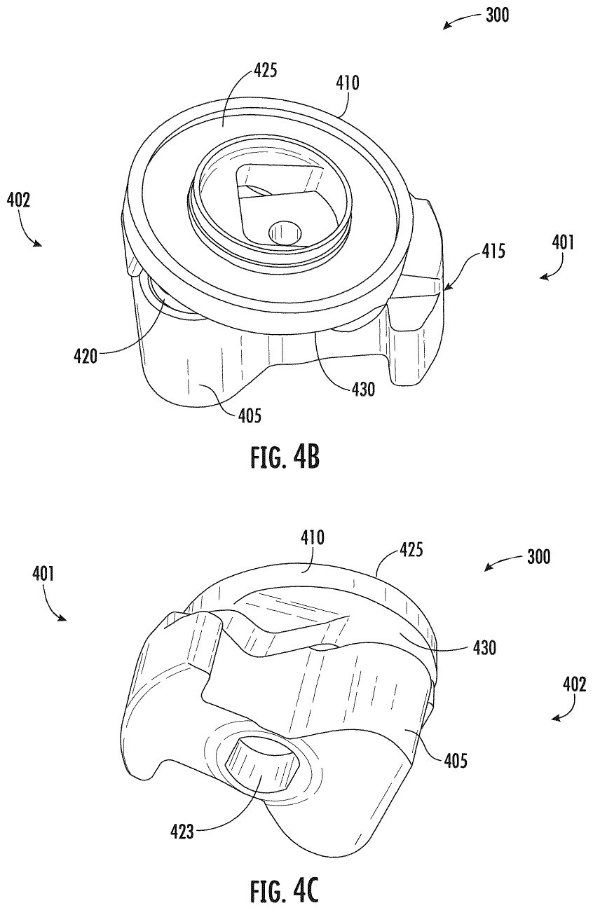

FIG. 4A illustrates a side perspective view of the wobble plate 300 of the pump assembly 135 of FIG. 3A in accordance with embodiments of the present disclosure. FIG. 4B illustrates a top perspective view of the wobble plate 300 of the pump assembly 135 of FIG. 3A in accordance with embodiments of the present disclosure. FIG. 4C illustrates a bottom perspective view of the wobble plate 300 of the pump assembly 135 of FIG. 3A in accordance with embodiments of the present disclosure.

In at least one example embodiment, the wobble plate 300 includes a base or a first plate 405 and a second plate 410. The wobble plate 300 extends between a first end 401 and a second end 402 opposite the first end 401. The first plate 405 and the second plate 410 are pivotably coupled closer to the first end 401 than the second end 402. For example, the wobble plate 300 may include a pivot point or hinged connection 415 adjacent the first end 401. Additionally, the wobble plate 300 may include a pin 435 at the hinged connection 415. The pin 435 may be configured to secure the second plate 410 to the first plate 405 such that the first plate 405 and the second plate 410 may rotate or pivot about the pin 435.

As shown in FIG. 4C, the first plate 405 of the wobble plate 300 defines a shaft opening 423. The shaft opening 423 is configured to receive a shaft (not shown) for mechanically coupling the first plate 405 of the wobble plate 300 to the electric motor 140. For example, the shaft opening 423 receives the shaft and transmits rotational motion from the electric motor 140 to the wobble plate 300 via the first plate 405.

Moreover, the first plate 405 may define a receptacle configured to receive at least one biasing member 420. In at least one example embodiment, the at least one biasing member 420 includes one or more springs, such as a torsion spring. In other example embodiments, the at least one biasing member 420 includes one or more leaf springs, elastomers, or other biasing elements. As shown in FIG. 4A, the at least one biasing member 420 includes two biasing members. However, it should be understood that the at least one biasing member 420 may include one biasing member. Alternatively, the at least one biasing member 420 may include three or more biasing members.

Still referring to FIGS. 4A-4C, the second plate 410 includes a first surface 425 and a second surface 430 opposite the first surface 425. The first surface 425 is configured to contact the plurality of pistons 305. The second surface 430 faces the first plate 405 and is in contact with the at least one biasing member 420 such that the at least one biasing member 420 may bias the second plate 410 relative to the first plate 405.

FIG. 5A illustrates a cross-sectional view of the wobble plate 300 of FIGS. 4A-4C at a first tilt angle in accordance with embodiments of the present disclosure. FIG. 5B illustrates a cross-sectional view of the wobble plate 300 of FIGS. 4A-4C at a second tilt angle in accordance with embodiments of the present disclosure. More specifically, FIGS. 5A-5B illustrate a cross-sectional view of the first plate 405 and the second plate 410 with the at least one biasing member 420 removed for clarity.

As described above, the second plate 410 is configured to rotate or pivot relative to the first plate 405. Additionally, or alternatively, the first plate 405 may be configured to rotate or pivot relative to the second plate 410. Moreover, the at least one biasing member 420 (FIGS. 4A-4C) is configured to bias the second plate 410 relative to the first plate 405 based on a pressure exerted on the wobble plate 300. The pressure exerted on the wobble plate 300 may be based on a size of an orifice of the nozzle attachment 130 coupled to the fluid outlet 125 of the sprayer. For example, as shown in FIGS. 1B-1C, the first nozzle 201 defining the first orifice 205 having the first diameter 210 may exert a higher pressure on the wobble plate 300 compared to the second nozzle 202 defining the second orifice 215 having the second diameter 220 that is greater than the first diameter 210. Accordingly, if the nozzle attachment 130, including one or both of the wand 132 and the nozzle 134, defines an orifice having a smaller size or diameter, a greater pressure is exerted on the wobble plate 300 such that a force of the at least one biasing member 420 is overcome and a tilt angle defined between the first plate 405 and the second plate 410 is decreased.

With reference to FIGS. 5A-5B, the wobble plate 300 defines a tilt angle 510 between the first plate 405 and the second plate 410. The tilt angle 510 may be defined between interior surfaces of the first plate 405 and the second plate 410. For example, a first central axis 501 (shown in FIG. 5A) extends through a center of the shaft opening 423 and a second central axis 502 (shown in FIG. 5B) extends though a center of an orifice 503 defines in the second plate 410. Moreover, the tilt angle 510 may be defined between a first reference line 515 extending perpendicular to the first central axis 501 and parallel to an interior surface 520 of the first plate 405 and a second reference line 525 extending perpendicular to the second central axis 502 and parallel to the second surface 430 of the second plate 410. The interior surface 520 of the first plate 405 at least partially faces the second surface 430 of the second plate 410. In at least one example embodiment, the tilt angle 510 may be less than or equal to 15 degrees. For example, the tilt angle 510 may be greater than or equal to 9.6 degrees and less than or equal to 13 degrees in some example embodiments.

The wobble plate 300 may define a first tilt angle 530, shown in FIG. 5A, and a second tilt angle 535, shown in FIG. 5B. The second tilt angle 535 is greater than the first tilt angle 530. Accordingly, the wobble plate 300 is configured to drive the plurality of pistons 305 such that a displacement of the plurality of pistons 305 is greater at the second tilt angle 535 than at the first tilt angle 530. In at least one example embodiment, the first tilt angle 530 may be less than or equal to 10 degrees and the second tilt angle 535 may be less than or equal to 15 degrees.

Moreover, a first pressure may be exerted on the wobble plate 300 of FIG. 5A and a second pressure different than the first pressure may be exerted on the wobble plate 300 of FIG. 5B. The first pressure may be greater than the second pressure. The pressure exerted on the wobble plate 300 may be defined by the size or diameter of the orifice of the nozzle attachment 130. For example, the first pressure may result from the nozzle attachment 130 having a smaller size or diameter such that a higher pressure is exerted on the wobble plate 300 and a force of the at least one biasing member 420 is overcome to bias the first plate 405 and/or the second plate 410 to the first tilt angle 530. In at least one example embodiment, the first tilt angle 530 may be less than or equal to about 10°. For example, the first tilt angle 530 may be about 9.6°. Additionally, a pressure exerted on the plurality of pistons 305 with the wobble plate 300 at the first tilt angle 530 may be less than or equal to about 2,100 pounds per square inch (PSI). For example, the pressure exerted on the plurality of pistons 305 at the first tilt angle 530 may be less than or equal to about 2,070 PSI.

Now referring to FIG. 5B, the second pressure exerted on the wobble plate 300 results from the nozzle attachment 130 having a larger size or diameter such that the force of the at least one biasing member 420 at least partially overcomes the second pressure to increase the tilt angle 510 to the second tilt angle 535. In at least one example embodiment, the second tilt angle 535 may include an unbiased position of the at least one biasing member 420. In some example embodiments, the second tilt angle 535 may be less than or equal to about 15°. For example, the second tilt angle 535 may be about 14°. Additionally, the pressure exerted on the plurality of pistons 305 with the wobble plate 300 at the second tilt angle 535 may be less than or equal to about 1,500 PSI. For example, the pressure exerted on the plurality of pistons 305 at the second tilt angle 535 may be less than or equal to about 1,300 PSI.

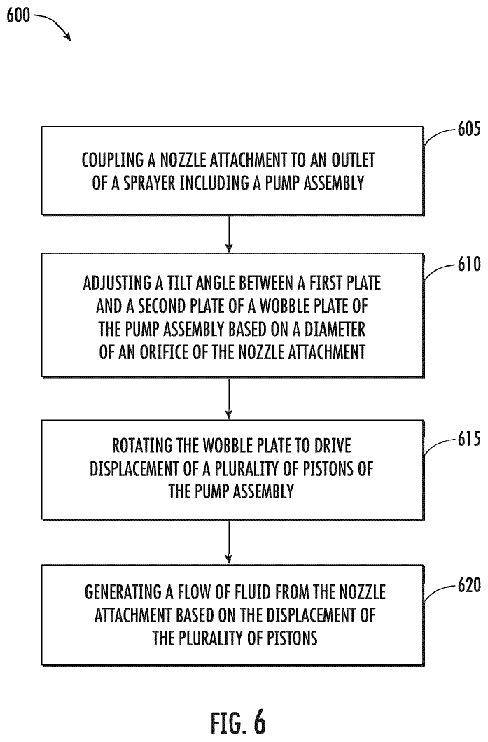

FIG. 6 illustrates a method 600 for controlling a flow rate of the high-pressure cleaning system of FIG. 1A in accordance with embodiments of the present disclosure.

In at least one example emobdiment, the method 600 includes coupling a nozzle attachment to an outlet of a sprayer including a pump assembly at 605, adjusting a tilt angle between a first plate and a second plate of a wobble plate of the pump assembly based on a diameter of an orifice of the nozzle attachment at 610, rotating the wobble plate to drive displacement of a plurality of pistons of the pump assembly at 615, and generating a flow of fluid from the nozzle attachment based on the displacement of the plurality of pistons at 620.

Coupling a nozzle attachment to an outlet of a sprayer including a pump assembly at 605 may include coupling the nozzle attachment 130 to the fluid outlet 125 of the sprayer 105. For example, one or both of the wand 132 and the nozzle 134 may be fluidly coupled to the fluid outlet 125 of the sprayer 105. Moreover, the nozzle 134 may include the first nozzle 201 or the second nozzle 202 shown in FIG. 2 in some example embodiments.

Adjusting a tilt angle between a first plate and a second plate of a wobble plate of the pump assembly based on a diameter of an orifice of the nozzle attachment at 610 may include adjusting the tilt angle 510 defined between the first plate 405 and the second plate 410 of the wobble plate 300. As discussed above with respect to FIGS. 5A-5B, the tilt angle 510 may be based on a size or diameter of an orifice of the nozzle attachment 130, such as the nozzle 134. The nozzle 134 may include the first nozzle 201 or the second nozzle 202. The first nozzle 201 may exert a higher pressure on the wobble plate 300 such that the tilt angle 510 is smaller. For example, the first nozzle 201 may exert the first pressure on the wobble plate 300 such that the first tilt angle 530 is defined between the first plate 405 and the second plate 410, as shown in FIG. 5A. The second nozzle 202 may exert a smaller pressure on the wobble plate 300 compared to the first nozzle 201 because the second nozzle 202 defines the second orifice 215 having the second diameter 220 that is greater than the first diameter 210 of the first orifice 205 of the first nozzle 201. Accordingly, the second nozzle may exert the second pressure on the wobble plate such that the second tilt angle 535 is defined between the first plate 405 and the second plate 410, as shown in FIG. 5B.

Rotating the wobble plate to drive displacement of a plurality of pistons of the pump assembly at 615 may include rotating the wobble plate 300 in the circumferential direction C about the central axis 310, as shown in FIG. 3A. The wobble plate 300 may be rotated by a rotatable shaft received by the shaft opening 423. Moreover, the wobble plate 300 may be rotated via the rotatable shaft by the electric motor 140 (FIG. 2). As the wobble plate 300 rotates, the plurality of pistons 305 are reciprocated in a sequential manner.

Generating a flow of fluid from the nozzle attachment based on the displacement of the plurality of pistons at 620 includes drawing fluid into the at least one fluid chamber 318 of each of the plurality of pistons 305 from the plurality of fluid inlets 320 and pushes the fluid, under pressure, from the at least one fluid chamber 318 to the plurality of fluid outlets 325 and out of the sprayer 105 through the fluid outlet 125, as discussed with respect to FIG. 3A. The flow of fluid may also define a flow rate based on the size or diameter of the orifice of the nozzle attachment 130, such as the nozzle 134. Accordingly, the flow rate may also be based on the tilt angle 510 defined between the first plate 405 and the second plate 410 of the wobble plate. For example, the flow rate of the flow of fluid may be greater at the second tilt angle 535 than at the first tilt angle 530 in some example embodiments.

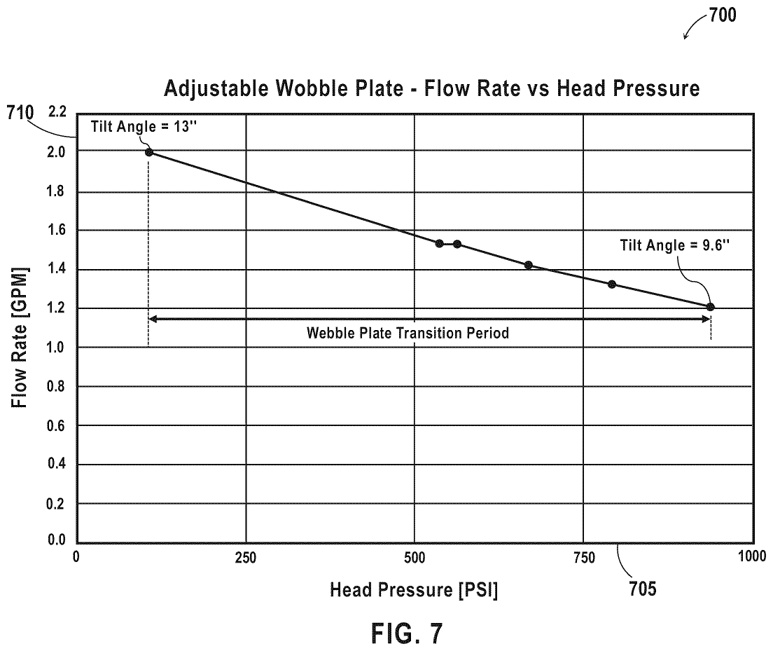

FIG. 7 is a graphical representation of flow rate relative to head pressure in accordance with embodiments of the present disclosure. More specifically, FIG. 7 provides a graph 700 depicting the flow rate in gallons per minute (GPM) as a function of the head pressure in pressure per square inch (PSI) for a transition period of the wobble plate 300. For example, the graph 700 provides the head pressure on the X-axis 705 and the flow rate on the Y-axis 710. The graph 700 depicts the transition period of the wobble plate 300 as the head pressure is increased and the piston biasing member 308, such as a spring, of each of the plurality of pistons 305 compress, which reduces both the tilt angle 510 and the flow rate.

Accordingly, the present disclosure provides a pump system of a sprayer of a sprayer cleaning system having a wobble plate with an adjustable tilt angle. The tilt angle of the wobble plate may be adjusted by a pressure exerted on the wobble plate, and such pressure may be based on a size of an orifice of a nozzle removably coupled to a fluid outlet of the sprayer. For example, a smaller orifice size may exert a higher pressure than a larger orifice size. The higher pressure may overcome a biasing force of the wobble plate to decrease the tilt angle. A lower pressure, such as that exerted by a nozzle having a smaller orifice size, may be at least partially overcome by the biasing force of the wobble plate to increase the tilt angle. Accordingly, the tilt angle of the wobble plate may be greater for a nozzle having a larger orifice size such that displacement of a plurality of pistons by the wobble plate is greater, and the tilt angle of the wobble plate may be smaller for a nozzle having a smaller orifice size such that the displacement of the plurality of pistons by the wobble plate is decreased. Such adjustment of the tilt angle creates an improved flow rate of fluid to be expelled from the sprayer for a given pressure (i.e., regardless of nozzle type and size).

Further aspects of the disclosure are provided by one or more of the following embodiments:

A pump assembly for a sprayer, the pump assembly comprising: a plurality of pistons extending between a first end and a second end; and a wobble plate for driving the plurality of pistons, the wobble plate comprising: a first plate, a second plate pivotably coupled to the first plate, and at least one biasing member disposed between the first plate and the second plate and configured to bias the first plate and the second plate between a first tilt angle and a second tilt angle based on a pressure exerted on the wobble plate.

The pump assembly of any one or more of the embodiments, wherein the second tilt angle is greater than the first tilt angle.

The pump assembly of any one or more of the embodiments, wherein the at least one biasing member biases the first plate and the second plate to the first tilt angle at a first pressure, and biases the first and second plate to the second tilt angle at a second pressure, the first pressure greater than the second pressure.

The pump assembly of any one or more of the embodiments, wherein: a pressure exerted by each of the plurality of pistons is less than or equal to 2100 PSI at the first tilt angle; and the pressure exerted by each of the plurality of pistons is less than or equal to 1500 PSI at the second tilt angle.

The pump assembly of any one or more of the embodiments, wherein: the first tilt angle is less than or equal to 10 degrees; and the second tilt angle is less than or equal to 15 degrees.

The pump assembly of any one or more of the embodiments, wherein the first plate and the second plate are pivotably coupled closer to a first end of the first plate and the at least one biasing member is disposed between the first plate and the second plate closer to a second end of the first plate opposite the first end.

The pump assembly of any one or more of the embodiments, wherein the at least one biasing member comprises at least one spring.

The pump assembly of any one or more of the embodiments, wherein the at least one spring comprises two springs.

The pump assembly of any one or more of the embodiments, further comprising: a pump body defining at least one fluid chamber, the plurality of pistons at least partially disposed in the at least one fluid chamber; a plurality of fluid inlets in fluid communication with the at least one fluid chamber, the plurality of fluid inlets configured to receive a flow of fluid from an external fluid source; and a plurality of fluid outlets in fluid communication with the at least one fluid chamber and downstream of the plurality of fluid inlets, the plurality of fluid outlets configured to receive the flow of fluid from the at least one fluid chamber.

The pump assembly of any one or more of the embodiments, wherein the at least one fluid chamber comprises three fluid chambers and the plurality of pistons comprises three pistons, and wherein one of the three pistons is disposed in each of the three fluid chambers.

The pump assembly of any one or more of the embodiments, further comprising a plurality of inlet valves in fluid communication with the plurality of fluid inlets and a plurality of outlet valves in fluid communication with the plurality of fluid outlets.

The pump assembly of any one or more of the embodiments, further comprising a plurality of piston biasing members configured to bias the plurality of pistons.

The pump assembly of any one or more of the embodiments, wherein the wobble plate is rotatable about a central axis.

The pump assembly of any one or more of the embodiments, wherein the wobble plate is rotatable about the central axis by a motive device.

The pump assembly of any one or more of the embodiments, wherein the motive device comprises an electric motor mechanically coupled to the wobble plate by a shaft.

The pump assembly of any one or more of the embodiments, wherein the wobble plate is configured to drive the plurality of pistons such that a displacement of the plurality of pistons is greater at the second tilt angle than the first tilt angle.

A sprayer, comprising: a sprayer including a housing defining a fluid inlet and a fluid outlet; at least one nozzle removably coupled to the fluid inlet, the at least one nozzle defining an orifice in fluid communication with the fluid outlet; and a pump assembly disposed within the housing of the sprayer in fluid communication with the fluid inlet and the fluid outlet, the pump assembly comprising: a plurality of pistons, and a wobble plate for driving the plurality of pistons, the wobble plate comprising a first plate, a second plate pivotably coupled to the first plate, and at least one biasing member disposed between the first plate and the second plate and configured to bias the first plate and the second plate between a first tilt angle and a second tilt angle based on a pressure exerted on the wobble plate.

The sprayer of any one or more of the embodiments, wherein the pressure exerted on the wobble plate is defined by a diameter of the orifice of the at least one nozzle.

The sprayer of any one or more of the embodiments, wherein the at least one biasing member biases the first plate and the second plate to the first tilt angle at a first pressure and biases the first and second plate to the second tilt angle at a second pressure, the first pressure greater than the second pressure.

The sprayer of any one or more of the embodiments, wherein a diameter of the orifice is greater at the second pressure than the diameter of the orifice at the first pressure.

A method for controlling flow rate of a sprayer, the method comprising: coupling a nozzle attachment defining an orifice to an outlet of the sprayer, wherein the sprayer includes a pump assembly comprising a plurality of pistons extending between a first end and a second end and a wobble plate for driving the plurality of pistons, and wherein the wobble plate comprises a first plate, a second plate, and at least one biasing member disposed between the first plate and the second plate; adjusting a tilt angle between the first plate and the second plate of the wobble plate based on a diameter of the orifice of the nozzle attachment; rotating the wobble plate to drive displacement of the plurality of pistons; and generating a flow of fluid from the nozzle attachment based on the displacement of the plurality of pistons.

The method of any one or more of the embodiments, wherein: the nozzle attachment comprises a first nozzle defining a first orifice having a first diameter and a second nozzle defining a second orifice having a second diameter, the second diameter is greater than the first diameter; and the tilt angle comprises a first tilt angle and a second tilt angle, the second tilt angle greater than the first tilt angle.

The method of any one or more of the embodiments, wherein the adjusting the tilt angle comprises: biasing the first plate and the second plate to the first tilt angle based on the first nozzle exerting a first pressure on the at least one biasing member; and biasing the first plate and the second plate to the second tilt angle based on the second nozzle exerting the second pressure on the at least one biasing spring; wherein the first pressure is greater than the second pressure.

The method of any one or more of the embodiments, wherein a flow rate of the flow of fluid is greater at the second tilt angle than at the first tilt angle.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A pump assembly for a sprayer, the pump assembly comprising:
a plurality of pistons extending between a first end and a second end; and
a wobble plate for driving the plurality of pistons, the wobble plate comprising:
a first plate,
a second plate pivotably coupled to the first plate, and
at least one biasing member disposed between the first plate and the second plate and configured to bias the first plate and the second plate between a first tilt angle and a second tilt angle based on a pressure exerted on the wobble plate.

2. The pump assembly of claim 1, wherein the second tilt angle is greater than the first tilt angle.

3. The pump assembly of claim 1, wherein the at least one biasing member biases the first plate and the second plate to the first tilt angle at a first pressure, and biases the first and second plate to the second tilt angle at a second pressure, the first pressure greater than the second pressure.

4. The pump assembly of claim 1, wherein the first plate and the second plate are pivotably coupled closer to a first end of the first plate and the at least one biasing member is disposed between the first plate and the second plate closer to a second end of the first plate opposite the first end.

5. The pump assembly of claim 1, wherein the at least one biasing member comprises at least one spring.

6. The pump assembly of claim 1, further comprising:
a pump body defining at least one fluid chamber, the plurality of pistons at least partially disposed in the at least one fluid chamber;
a plurality of fluid inlets in fluid communication with the at least one fluid chamber, the plurality of fluid inlets configured to receive a flow of fluid from an external fluid source; and
a plurality of fluid outlets in fluid communication with the at least one fluid chamber and downstream of the plurality of fluid inlets, the plurality of fluid outlets configured to receive the flow of fluid from the at least one fluid chamber.

7. The pump assembly of claim 6, wherein the at least one fluid chamber comprises three fluid chambers and the plurality of pistons comprises three pistons, and wherein one of the three pistons is disposed in each of the three fluid chambers.

8. The pump assembly of claim 6, further comprising a plurality of inlet valves in fluid communication with the plurality of fluid inlets and a plurality of outlet valves in fluid communication with the plurality of fluid outlets.

9. The pump assembly of claim 1, further comprising a plurality of piston biasing members configured to bias the plurality of pistons.

10. The pump assembly of claim 1, wherein the wobble plate is rotatable about a central axis.

11. The pump assembly of claim 10, wherein the wobble plate is rotatable about the central axis by a motive device.

12. The pump assembly of claim 11, wherein the motive device comprises an electric motor mechanically coupled to the wobble plate by a shaft.

13. The pump assembly of claim 1, wherein the wobble plate is configured to drive the plurality of pistons such that a displacement of the plurality of pistons is greater at the second tilt angle than the first tilt angle.

14. A sprayer washer, comprising:
a sprayer including a housing defining a fluid inlet and a fluid outlet;
at least one nozzle removably coupled to the fluid inlet, the at least one nozzle defining an orifice in fluid communication with the fluid outlet; and
a pump assembly disposed within the housing of the sprayer in fluid communication with the fluid inlet and the fluid outlet, the pump assembly comprising:
a plurality of pistons, and
a wobble plate for driving the plurality of pistons, the wobble plate comprising a first plate, a second plate pivotably coupled to the first plate, and at least one biasing member disposed between the first plate and the second plate and configured to bias the first plate and the second plate between a first tilt angle and a second tilt angle based on a pressure exerted on the wobble plate.

15. The sprayer washer of claim 14, wherein the pressure exerted on the wobble plate is defined by a diameter of the orifice of the at least one nozzle.

16. The sprayer washer of claim 14, wherein the at least one biasing member biases the first plate and the second plate to the first tilt angle at a first pressure and biases the first and second plate to the second tilt angle at a second pressure, the first pressure greater than the second pressure.

17. The sprayer washer of claim 16, wherein a diameter of the orifice is greater at the second pressure than the diameter of the orifice at the first pressure.

18. A method for controlling flow rate of a sprayer, the method comprising:
coupling a nozzle attachment defining an orifice to an outlet of the sprayer, wherein the sprayer includes a pump assembly comprising a plurality of pistons extending between a first end and a second end and a wobble plate for driving the plurality of pistons, and wherein the wobble plate comprises a first plate, a second plate, and at least one biasing member disposed between the first plate and the second plate;
adjusting a tilt angle between the first plate and the second plate of the wobble plate based on a diameter of the orifice of the nozzle attachment;
rotating the wobble plate to drive displacement of the plurality of pistons; and
generating a flow of fluid from the nozzle attachment based on the displacement of the plurality of pistons.

19. The method of claim 18, wherein:
the nozzle attachment comprises a first nozzle defining a first orifice having a first diameter and a second nozzle defining a second orifice having a second diameter, the second diameter is greater than the first diameter; and
the tilt angle comprises a first tilt angle and a second tilt angle, the second tilt angle greater than the first tilt angle.

20. The method of claim 19, wherein the adjusting the tilt angle comprises:
biasing the first plate and the second plate to the first tilt angle based on the first nozzle exerting a first pressure on the at least one biasing member; and
biasing the first plate and the second plate to the second tilt angle based on the second nozzle exerting a second pressure on the at least one biasing member;
wherein the first pressure is greater than the second pressure.
